(19) United States
(12) Patent Application Publication
(10) Pub. No.: US 2002/0161104 A1
(43) Pub. Date: Oct. 31, 2002

(54) Anti-pollution topical composition

(75) Inventors: Emmanuelle Labrousse, Igny (FR); Jose Cotovio, Dammartin en Goele (FR)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: L'OREAL, Paris (FR)

(21) Appl. No.: 10/067,421

(22) Filed: Feb. 7, 2002

(30) Foreign Application Priority Data
Feb. 7, 2001 (FR) 0101645

(51) Int. Cl. C08J 3/00

(52) U.S. Cl. 524/588

(57) ABSTRACT

The present application relates to the use of starch as an anti-pollution agent. The application also relates to a composition for topical application containing, in a physiologically acceptable medium, at least one starch and at least one silicone gum, and to its uses in cosmetics and dermatology.

### BACKGROUND OF THE INVENTION

1. Field of the Invention

The present application relates to the use for example, in topical application, of starch as an antipollution agent, and to a cosmetic treatment process for protecting the body against the effects of pollution, for example by applying to keratin materials a composition containing an effective amount of starch in a physiologically acceptable medium.

The application also relates to an antipollution composition for topical application containing, in a physiologically acceptable medium, at least one starch and at least one silicone gum, and to its uses in cosmetics and dermatology.

2. Discussion of the Background

Urban environments are regularly subjected to peaks of pollution. An individual in his daily environment, and particularly in an urban zone, may be subjected to a whole range of factors attacking keratin materials, and in particular the skin, the scalp and the hair, by various airborne pollutants. Atmospheric pollutants which are represented largely by the primary and secondary products of combustion represent a major source of environmental oxidative stress. Urban pollution is composed of various types of chemical and xenobiotic products and particles. The major categories of pollutants which may exert harmful effects on the skin and the hair are as follows: gases, heavy metals, polycyclic aromatic hydrocarbons (PAHs) and particulate elements which are combustion residues onto which are adsorbed a very large number of organic and mineral compounds.

It is the outermost tissues that are initially and directly exposed to environmental toxins. The skin is directly and frequently exposed to the prooxidative environment and it is particularly sensitive to the action of oxidative stress; its outermost layer serves as a barrier to oxidative damage which may take place. In the majority of circumstances, the oxidizing agent is generally neutralized after reaction with the keratin materials, but the reaction products formed may be responsible for attacks on cells and tissues. The stratum corneum, the skin's barrier, is the site of contact between the air and skin tissue, and the lipid/protein two-phase structure is a crucial factor of this barrier function of the skin. These elements may react with the oxidizing agents and become impaired, which will promote the desquamation phenomena.

Among the pollutants that may exert deleterious effects on keratin materials, toxic gases such as ozone, carbon monoxide, nitrogen oxides or sulphur oxides are among the major constituents of pollutants. It has been found that these toxic gases promote the desquamation of keratin materials; they “fatigue” the keratin materials, that is to say make them dull and dirty. Similarly, cellular asphyxia of the keratin materials has been observed.

It is known that heavy metals (lead, cadmium and mercury) are atmospheric pollutants whose emissions have increased considerably, especially in urban and industrial environments. Although the majority of the effects of these metals are described in other tissues (lungs, kidneys, brain, etc.), it has been shown that certain metals can penetrate into the skin and become accumulated therein (A. B. G. Landsdown, Critical Reviews in Toxicology, 1995, Vol. 25, pp. 397462). At high concentrations, heavy metals can induce oxidation mechanisms on membrane lipids, a direct cytotoxicity capable of resulting in cellular necrosis, an alkylation of cellular nucleophiles via mechanisms which may be at the origin of sensitization or carcinogenesis phenomena (S. J. Stochs and D. Bagchi, Free Radical Biology and Medicine, 1995, Vol. 18, pp. 321-336; M. E. Figueiredo-Pereira et al., The Journal of Biological Chemistry, 1998, Vol. 21, pp. 12703-12709.; N.L. Acan et al., 1995, Biochemical and Molecular Medicine, Vol. 54, pp. 33-37).

In addition to certain toxic effects which they cause, heavy metals have the property of reducing the activity of the cellular defense means against free radicals [see for example R. S. Dwivedi, J. Toxicol. Cut. & Ocular Toxical. 6(3), 183-191 (1987)). Thus, heavy metals aggravate the toxic effects of gaseous pollutants by reducing the efficacy of the natural defense means, and bring about an acceleration of the phenomenon of cell ageing. This is particularly true for keratin materials and especially the skin, the scalp and the hair, which are in direct and permanent contact with the external environment.

Another major category of pollutants consists of combustion residues in the form of particles onto which are adsorbed a very large number of organic compounds, and in particular of polycyclic aromatic hydrocarbons (PAHs). These PAHs adsorbed at the surface of the particles and dusts borne by the urban atmosphere can penetrate into skin tissue and become stored and/or biotransformed therein. Their metabolism in the liver, which is well described in the literature, leads to formations of monohydroxylated metabolites (detoxification route), epoxides and diol epoxides (toxifying route). Similar phenomena may be observed in the skin. These compounds are known to have carcinogenic and immunogenic effects on the skin.

Thus, the harmful effects of pollution on keratin materials affect cell respiration and are reflected by accelerated ageing of the skin, with a dull complexion and the early formation of wrinkles or fine lines, and also by a reduction in the vigour of the hair, which thus acquires a dull appearance. In addition, due to pollution, the skin and hair become dirty more quickly. Furthermore, pollution can cause irritations and allergic phenomena and inflammation on the skin.

Various anti-pollution agents have been described to combat these effects of pollutants. Thus, document EP-A-557 042 describes the use of metallothionines to protect tissues against heavy metals. Moreover, document EP-A-577 718 describes the use of sphingolipids to protect the skin and the hair against atmospheric pollution.

### OBJECTS OF THE INVENTION

With pollution on the increase, there is a need for other agents for effectively combating the harmful effect of pollutants on keratin materials and to prevent the adhesion of these pollutants on keratin materials, and in particular to avoid the degradation of cell respiration, the desquamation and accelerated ageing of keratin materials and especially the skin, and also to combat the dull complexion and the early formation of wrinkles and fine lines on the skin, to prevent hair from having a dull appearance and from becoming dirty, and to avoid irritation of the skin and also skin allergy phenomena and skin inflammation. The inventors have now found, entirely surprisingly, that the use of one or a mixture of starches addresses these issues and in addition makes it possible to protect keratin materials against the effects of pollutants and especially of particulate pollutants, and that, in addition, the combination of a starch with a silicone gum makes it possible to increase the anti-pollution effect of starch.

### DETAILED DESCRIPTION OF THE INVENTION

It is known practice to use starch in compositions for topical application and cosmetic compositions, intended to be applied to the skin, for example as a filler (see for example EP-A-925 777 and EP-A-745 379). However, no document describes or suggests that these compounds can have properties of protecting keratin materials against pollution. Thus, one subject of the invention is the use of at least one starch as an antipollution agent, in a composition for (topical) application to keratin materials.

A subject of the invention is also the use of at least one starch to prepare a topical-application composition for protecting keratin materials against the harmful effects of pollution, especially particulate pollution, such as inflammation of the skin and skin allergy problems.

Also making up a part of the invention is an article of manufacture comprising a composition comprising starch and, associated therewith, instructions and/or indicia relating to the use/applicability of the composition as a pollution protectant.

The expression “anti-pollution agent” means an agent which protects the skin and keratin materials so as to prevent, attenuate and/or eliminate the deleterious effects of pollutants (e.g. PAHs, heavy metals, etc.), especially those adsorbed onto particles.

In the context of the present invention, the expression “keratin material” means the skin, the scalp, the hair, the eyelashes, the eyebrows, the nails and mucous membranes.

The expression “topical application” means herein an external application, for example to keratin materials, including the skin, the scalp, the eyelashes, the eyebrows, the nails and mucous membranes, and any cutaneous tissue in general.

The composition used according to the invention is preferably intended for topical application and thus preferably contains a physiologically acceptable medium, that is to say a medium that is compatible with cutaneous tissues and keratin material such as the skin, the scalp, the eyelashes, the eyebrows, the nails and mucous membranes. Thus, a preferred composition may be applied to the entire human body.

The starch(es) used as anti-pollution compounds according to the invention is (are) advantageously present in a sufficient amount. The expression “sufficient amount” (or “effective amount”) means herein an amount such that protection against pollutants is ensured. This amount may range, for example, from 0.05% to 15% by weight, preferably from 0.1% to 10% by weight and better still from 0.5% to 7% by weight of active material of anti-pollution compound(s) relative to the total weight of the composition, including 1, 2, 3, 4, 5, 6, 8, 9, 11, 12, 13 and 14% by weight relative to the total weight of the composition. This amount varies according to the compound(s) used and the medium for the composition.

Starch is a natural product that is well known to those skilled in the art. It is a polymer or a mixture of polymers, that are linear or branched, of α-D-glucopyranosyl units. Starch is described in “Kirk-Othmer Encyclopedia of Chemical Technology, 3rd edition, Volume 21, pp. 492-507, Wiley Interscience, 1983”.

Preferred starches and starch derivatives which may be used in the present invention are macromolecules in the form of polymers consisting of elemental units which are anhydroglucose units. The number of these units and their assembly make it possible to distinguish amylose (linear polymer) and amylopectin (branched polymer). The relative proportions of amylose and of amylopectin, and also their degree of polymerization, vary as a function of the botanical origin of the starches.

The origin of the starches used in the present invention is not limited. Botanical origin includes cereals and tubers. Thus, the starches may be chosen, for example, from corn starch, rice starch, cassava starch, potato starch, wheat starch, sorghum starch and pea starch, that are unmodified (i.e. unmodified) or modified, and mixtures thereof. Examples of modified starches include precooked starches, hydrolysed starches, crosslinked starches, for example crosslinked with a methylolurea derivative or with octenylsuccinic anhydride or with epichlorohydrin, esterified starches, etherified starches, oxidized starches, purified starches, starches grilled in the presence of acid, or grafted starches, for example starches grafted with sodium polyacrylates, coated starches, for example starches coated with amino acids, and/or mixtures thereof.

The starches may generally be in the form of a white powder, which is insoluble in cold water and which has an elemental particle size ranging from 3 to 100 microns. This powder forms a gel when it is heated.

Starches and derivatives thereof which are particularly suitable for the invention include:

corn starch (unmodified starch) such as the product sold under the name “Amidon de mais B” by the company Roquette Freres and the product sold under the name “Amidon de mais” [corn starch] by the company National Starch;

the modified starch (amylopectin/amylose crosslinked with epichlorohydrin) sold under the trade name “Amidon de riz insoluble non mucilagineux” [non-mucilaginous insoluble rice starch] by the company Remy,

the unmodified waxy corn starch (essentially amylopectin) sold under the trade name “Waxy Mais” [Waxy Corn] by Blattmann,

the modified and precooked wheat starch sold under the trade name “Midsol Krisp” by Midwest Grain Products,

the modified and purified wheat starch sold under the trade name “Midsol Adhere” by Midwest Grain Products,

the modified wheat starch powder sold under the trade name “Midsol 35” by Midwest Grain Products,

the modified potato starch sold under the trade name “Perfectagel MPT” by Avebe.

Of course, a mixture of these starches may be used.

In one particularly advantageous form of the invention, the starch used is an unmodified starch and preferably corn starch.

One or more silicone gums may optionally, but advantageously be added to the starch(es) used according to the invention.

In the context of the present invention, the expression “silicone gum” denotes non-crosslinked linear polydimethylsiloxanes which may be hydroxylated or phenylated and which have the consistency of a thick oil or of a transparent solid, in contrast with alkyl or alkoxydimethicones which, when they are solid, have an opaque waxy appearance, but may also have the appearance of a clear oil when their melting point is below room temperature.

Silicone gums useful in the invention include polydiorganosiloxanes with a weight average molecular weight ranging from 100 000 to 2 000 000 and preferentially from 100 000 to 1 500 000. These silicone gums preferentially have a viscosity of greater than or equal to 200 000 cSt (0.2 m²/s) and more preferentially greater than 300 000 cSt (0.3 m²/s), the viscosity being measured using a Brookfield viscometer at 25° C.

One silicone gum preferably used is chosen from the compounds of formula (I) below:

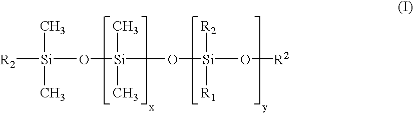

in which:

R1 represents —CH₃, —OH, —C₆H₅ or —OSi (CH₃)₃,

R2 represents —CH₃, —OH or —C₆H₅,

x=0 or an integer and

y is an integer,

y or x+y being integers such that the weight-average molecular weight is preferably greater than 100 000 and more preferably ranges from 100 000 to 1 500 000.

Other preferred silicone gums of the invention include dimethicones (polydimethylsiloxanes) and more particularly dimethiconols (polydimethylsiloxanes with a hydroxyl end group).

One or more silicone gums may be used, and the silicon gum(s) may be present in unmodified form (at 100% active material) or as a mixture with a solvent, preferably a solvent chosen from volatile silicones, polydimethylsiloxane oils, polyphenylmethylsiloxane oils, isoparaffins, methylene chloride, pentane, dodecane, tridecane and tetradecane, or mixtures thereof.

The silicone gums are generally marketed by the suppliers as a mixture with a linear or cyclic polydimethylsiloxane, of low molecular weight, which is volatile or non-volatile, in a proportion of from 5% to 20% by weight of active material and preferably from 10% to 15% by weight of active material relative to the total weight of the mixture. Examples include 96% dimethicone in cyclomethicone, sold by the company Rhone-Poulenc under the name Mirasil DM-500000®; the dimethicone sold by the company Wacker under the name AK 300000®, and the dimethiconols as a mixture with a dimethicone or a cyclomethicone, sold under the names Q2-1403®, Q2-1401®, Q2-1503®, DC2-9085® a by the company Dow Corning.

The invention also relates to a topical-application composition containing, in a physiologically acceptable medium, at least one unmodified starch chosen from corn starch, rice starch, cassava starch, potato starch, wheat starch, sorghum starch and pea starch, and at least one silicone gum.

In the composition according to the invention, the amount of starch preferably ranges from 0.05% to 15% by weight (of active material), better still from 0.1% to 10% by weight and even better still from 0.5% to 7% by weight, including 1, 2, 3, 4, 5, 6, 7, 8, 9, 10, 11, 12, 13 and 14% by weight, relative to the total weight of the composition, and the amount of silicone gum, (if present) preferably ranges from 0.01% to 10% by weight (of active material), better still from 0.05% to 5% by weight and even better still from 0.1% to 3% by weight, including 1, 2, 3, 4, 5, 6, 7, 8 and 9% by weight, relative to the total weight of the composition.

The topical-application compositions, and especially cosmetic compositions, used according to the invention preferably contain a physiologically acceptable medium. This physiologically acceptable medium may contain water and optionally a physiologically acceptable organic solvent chosen, for example, from lower alcohols containing from 1 to 8 carbon atoms and in particular 1 to 6 carbon atoms, for instance ethanol, isopropanol, propanol and butanol; polyethylene glycols containing from 6 to 80 ethylene oxides; polyols, for instance propylene glycol, isoprene glycol, butylene glycol, glycerol and sorbitol. It may also be an anhydrous medium, especially an oily medium containing oils and/or fatty substances other than oils.

When the physiologically acceptable medium is an aqueous medium, it preferably has a pH that is compatible with the skin, preferably ranging from 3 to 8 and better still from 4 to 7.

When the composition comprises an aqueous or aqueous-alcoholic medium, it is possible to add a fatty (or oily) phase to this medium, so that the compositions of the invention are softer and more nourishing.

The compositions according to the invention containing one or more anti-pollution agents as defined above may be in any form, for example any pharmaceutical form conventionally used for topical application, and especially in the form of aqueous, aqueous-alcoholic or oily solutions, oil-in-water (O/W) or water-in-oil (W/O) or multiple (triple: W/O/W or O/W/O) emulsions, aqueous or oily gels, liquid, pasty or solid anhydrous products, or dispersions of a fatty phase in an aqueous phase with the aid of spherules, these spherules possibly being polymer nanoparticles such as nanopheres and nanocapsules, or lipid vesicles of ionic and/or nonionic type. These compositions may be prepared according to the usual methods, which is within the skill of the ordinary artisan in view of this disclosure.

In addition, the compositions used according to the invention may be more or less fluid and may have the appearance of a white or coloured cream, an ointment, a milk, a lotion, a serum, a paste or a mousse. They may optionally be applied to the skin in the form of an aerosol. They may also be in solid form and, for example, in the form of a stick.

When the composition used according to the invention comprises an oily phase, this phase preferably contains at least one oil. It may also contain other fatty substances. As oils which can be used in the composition of the invention, mention may be made for example of:

hydrocarbon-based oils of animal origin, such as perhydrosqualene;

hydrocarbon-based plant oils such as liquid triglycerides of fatty acids of 4 to 10 carbon atoms, such as heptanoic or octanoic acid triglycerides or alternatively, for example, sunflower oil, corn oil, soybean oil, marrow oil, grapeseed oil, sesame oil, hazelnut oil, apricot oil, macadamia oil, arara oil, castor oil, avocado oil, caprylic/capric acid triglycerides such as those sold by the company Stearineries Dubois or those sold under the names Miglyol 810, 812 and 818 by the company Dynamit Nobel, jojoba oil or Karite butter oil;

synthetic esters and ethers in particular of fatty acids, such as the oils of formulae R¹COOR² and R¹OR² in which R¹ represents a fatty acid residue containing from 8 to 29 carbon atoms and R² represents a branched or unbranched hydrocarbon-based chain containing from 3 to 30 carbon atoms, such as, for example, purcellin oil, isononyl isononanoate, isopropyl myristate, 2-ethylhexyl palmitate, 2-octyldodecyl stearate, 2-octyldodecyl erucate or isostearyl isostearate; hydroxylated esters such as isostearyl lactate, octyl hydroxystearate, octyldodecyl hydroxystearate, diisostearyl malate, triisocetyl citrate, and fatty alkyl heptanoates, octanoates and decanoates; polyol esters such as propylene glycol dioctanoate, neopentyl glycol diheptanoate or diethylene glycol diisononanoate; and pentaerythritol esters such as pentaerythrityl tetraisostearate;

linear or branched hydrocarbons of mineral or synthetic origin, such as volatile or non-volatile liquid paraffins and derivatives thereof, petroleum jelly, polydecenes or hydrogenated polyisobutene such as parleam; —fatty alcohols containing from 8 to 26 carbon atoms, such as cetyl alcohol, stearyl alcohol, and the mixture thereof (cetylstearyl alcohol), octyldodecanol, 2-butyloctanol, 2-hexyldecanol, 2-undecylpentadecanol, oleyl alcohol or linoleyl alcohol;

partially hydrocarbon-based and/or silicone-based fluoro oils such as those described in document JP-A-2 295 912;

silicone oils such as volatile or non-volatile polydimethylsiloxanes (PDMSs) containing a linear or cyclic silicone chain, which are liquid or pasty at room temperature, in particular cyclopolydimethylsiloxanes (cyclomethicones) such as cyclohexasiloxane; polydimethylsiloxanes comprising alkyl, alkoxy or phenyl groups, pendant or at the end of a silicone chain, these groups containing from 2 to 24 carbon atoms; phenylsilicones such as phenyl trimethicones, phenyl dimethicones, phenyltrimethylsiloxydiphenylsiloxanes, diphenyl dimethicones, diphenylmethyldiphenyltrisiloxanes, 2-phenylethyl trimethylsiloxysilicates and polymethylphenylsiloxanes;

mixtures thereof.

In the list of oils mentioned above, the expression “hydrocarbon-based oil” means any oil predominantly comprising carbon and hydrogen atoms, and optionally ester, ether, fluoro, carboxylic acid and/or alcohol groups.

Other fatty substances which may be present in the oily phase are, for example, fatty acids containing from 8 to 30 carbon atoms, for instance stearic acid, lauric acid, palmitic acid or oleic acid; waxes, for example lanolin, beeswax, carnauba wax, candelilla wax, paraffin wax, lignite wax or microcrystalline waxes, ceresin or ozokerite, synthetic waxes, for instance polyethylene waxes and Fischer-Tropsch waxes; silicone resins such as trifluoromethyl-C1-4-alkyldimethicone and trifluoropropyldimethicone; and silicone elastomers, for instance the products sold under the names “KSG” by the company Shin-Etsu, under the names “Trefil”, “BY29” and “EPSX” by the company Dow Corning or under the names “Gransil” by the company Grant Industries.

These substances may be chosen in order to prepare a composition having the desired properties, for example consistency or texture properties, which is within the skill of the ordinary artisan in view of this disclosure.

According to one particular embodiment of the invention, the composition containing the antipollution compounds is a water-in-oil (W/O) or oil-in-water (O/W) emulsion, and more particularly an O/W emulsion. The proportion of the oily phase of the emulsion may range, for example, from 5% to 80% by weight and preferably from 5% to 50% by weight relative to the total weight of the composition. The oils, the emulsifiers and the coemulsifiers used in the composition in emulsion form can be chosen from those conventionally used in cosmetics or dermatology. The emulsifier and the coemulsifier are generally present in the composition in a proportion ranging from 0.3% to 30% by weight and preferably from 0.5% to 20% by weight relative to the total weight of the composition. The emulsion may also contain lipid vesicles.

The emulsions may generally contain at least one emulsifier chosen from amphoteric, anionic, cationic or nonionic emulsifiers, used alone or as a mixture. The emulsifiers are chosen in an appropriate manner depending on the emulsion to be obtained (W/O or O/W emulsion), which is within the skill of the artisan.

For the W/O emulsions, mention may be made, for example, as emulsifiers, of dimethicone copolyols such as the mixture of cyclomethicone and of dimethicone copolyol, sold under the name “DC 5225 C” by the company Dow Corning, and alkyldimethicone copolyols such as the laurylmethicone copolyol sold under the name “Dow Corning 5200 Formulation Aid” by the company Dow Corning, and cetyl dimethicone copolyol sold under the name Abil EM 90® by the company Goldschmidt. Surfactants for W/O emulsions which may also be used include a crosslinked elastomeric solid polyorganosiloxane comprising at least one oxyalkylenated group, such as those obtained according to the procedure of Examples 3, 4 and 8 of document U.S. Pat. No. 5,412,004 and of the examples of document U.S. Pat. No. 5,811,487, especially the product of Example 3 20 (synthesis example) of U.S. Pat. No. 5,412,004, and such as the product sold under the reference KSG 21 by the company Shin Etsu.

For the O/W emulsions, mention may be made, for example, as emulsifiers, of nonionic emulsifiers such as oxyalkylenated (more particularly polyoxyethylenated) fatty acid esters of glycerol, oxyalkylenated fatty acid esters of sorbitan, oxyalkylenated (oxyethylenated and/or oxypropylenated) fatty acid esters, oxyalkylenated (oxyethylenated and/or oxypropylenated) fatty alcohol ethers, and sugar esters, for instance sucrose stearate, and mixtures thereof, such as the mixture of glyceryl stearate and PEG-40 stearate sold under the name Arlacel 165 by the company Uniqema.

The compositions of the invention may also contain adjuvants that are common in cosmetics or dermatology, such as hydrophilic or lipophilic gelling agents, hydrophilic or lipophilic active agents, preserving agents, antioxidants, solvents, fragrances, fillers, screening agents, bactericides, odour absorbers, dyestuffs and salts. The amounts of these various adjuvants are those conventionally used in the field under consideration, and, for example, from 0.01% to 20% of the total weight of the composition. Depending on their nature, these adjuvants may be introduced into the fatty phase, into the aqueous phase and/or into the lipid spherules.

Fillers which may be used in the composition of the invention, include, for example, besides pigments, silica powder; talc; polyamide particles and especially those sold under the name Orgasol by the company Atochem; polyethylene powders; microspheres based on acrylic copolymers, such as those made of ethylene glycol dimethacrylate/lauryl methacrylate copolymer, sold by the company Dow Corning under the name Polytrap; expanded powders such as hollow microspheres, and especially the microspheres sold under the name Expancel by the company Kemanord Plast or under the name Micropearl F 80 ED by the company Matsumoto; silicone resin microbeads such as those sold under the name Tospearl by the company Toshiba Silicone; and mixtures thereof. These fillers may be present in amounts ranging from 0% to 20% by weight and preferably from 1% to 10% by weight relative to the total weight of the composition.

Hydrophilic gelling agents include carboxyvinyl polymers, for instance the products sold under the names Carbopol (CTFA name: carbomer) by the company Goodrich, acrylic copolymers such as acrylate/alkylacrylate copolymers, polyacrylamides, polysaccharides such as cellulose derivatives and especially hydroxyethylcellulose, natural gums and clays. Lipophilic gelling agents include modified clays, for instance bentones, metal salts of fatty acids, hydrophobic silica and polyethylenes.

According to one preferred embodiment of the invention, the composition according to the invention contains at least one UV screening agent (or sunscreen) which may be a chemical screening agent or a physical sunblock or a mixture of such screening agents.

Examples of UV screening agents that are particularly suitable for use in the present invention include:

butylmethoxydibenzoylmethane sold especially by the company Hoffmann-Laroche under the name Parsol 1789, —octocrylene sold especially by the company BASF under the name Uvinul N539,

octyl salicylate sold especially by the company Haarman-Reimer under the name Neo Heliopan OS,

octyl methoxycinnamate sold especially by the company Hoffmann-Laroche under the name Parsoli MCX,

phenylbenzimidazolesulphonic acid sold especially by the company Merck under the name Eusol, ex 232,

oxybenzones such as benzophenones-3, -4 or -5,

benzotriazole silicones and in particular drometrizole trisiloxane,

terephthalylidenedicamphorsulphonic acid, and

titanium oxide or zinc oxide, in the form of microparticles or nanoparticles (nanopigments), that are optionally coated.

Screening agents that are preferably used in the composition of the invention include octyl methoxycinnamate (Parsol MCX from the company Hoffmann-Laroche), terephthalylidenedicamphorsuhphonic acid (Mexoryl SX from the company Chimex), benzophenone-3 (Uvinul M40 from the company BASF) and phenylbenzimidazolesulphonic acid (Eusolex 232 from the company Merck), and mixtures thereof.

The amount of screening agents depends on the intended final use. It may range, for example, from 0.5% to 20% by weight, preferably from 2% to 15% by weight and better still from 2% to 101 by weight relative to the total weight of the composition.

The compositions used according to the invention may especially constitute a care product and/or make-up product for keratin materials, and especially for the skin. They may be used especially to protect the body, in particular keratin materials, against the effects of pollution, and a specially to improve cell respiration and/or to reduce desquamation and/or to prevent keratin materials, and especially the skin, from becoming dull and dirty.

Thus, another subject of the invention is a cosmetic treatment process for protecting a keratin material (skin, hair or the like) against the effects of pollution, which comprises applying to the keratin material a composition containing an effective amount of at least one starch.

Another subject of the invention is also a cosmetic treatment process for keratin material in order to improve its cell respiration and/or to reduce its desquamation and/or to prevent it from becoming dull and/or dirty, which comprises applying to the keratin material a composition containing, in a physiologically acceptable medium, an effective amount of at least one starch.

Another part of the invention is an article of manufacture comprising a composition comprising at least one starch and optionally a silicone gum and, associated therewith, instructions and/or indicia relating to the use of the composition as a pollution protectant and/or indicating the ability of the composition to provide such protection.

The examples which follow serve to illustrate the invention without, however, being limiting in nature. The names are, depending on the case, the chemical names or CTFA names (International Cosmetic Ingredient Dictionary and Handbook) and the amounts are in percentages by weight, except where otherwise mentioned.

### I. COMPOSITION EXAMPLES

### Example 1: O/W Emulsion

| Oily phase (phase A) | | |
|---|---|---|
| Apricot oil | | 3% |
| Silicone oil | | 5% |
| Karite oil | | 3% |
| Pentaerythrityl tetraoctanoate | | 3% |
| Glyceryl stearate/PEG-40 stearate (Arlacel 165) | | 3% |
| Stearyl alcohol | | 1% |
| Screening agents (Parsol MCX and Benzopbenone-3) | | 9.5% |
| Phase B | | |
| Starch | | 0.5% |
| Silicone gum containing 12% A.M. (DC2-9085) | | 0.2% |
| (i.e. 0.024% dimethiconol and 0.176% dimethicone) | | |
| Gelling agents (phase C) | | |
| Hydroxyethylcellulose | | 0.1% |
| Carbomer (carbopol) | | 0.6% |
| Aqueous phase (phase D) | | |
| Preserving agent | | qs |
| Glycerol | | 5% |
| Water | qs | 100% |
| Phase E | | |
| Triethanolamine (neutralizer) | qs pH | 6 |

Procedure:

The oily and aqueous phases are prepared separately at 70° C. and the oily phase is poured into the aqueous phase with stirring. The mixture is stirred for 10 minutes to produce the emulsion, phase C is then added, followed by phase B and finally phase E to neutralize the carbopol.

A cream is obtained, which can be applied to the skin to protect it against the effects of pollution and especially to limit the adhesion of pollutant particles to the skin.

### Example 2: O/W Emulsion

| Oily phase (phase A) | | |
|---|---|---|
| Apricot oil | | 1% |
| Silicone oil | | 5% |
| Octyldodecanol (Eutanol G from the company Henkel) | | 1% |
| Screening agents (Parsol MCX and Benzophenone-3) | | 9.5% |
| Phase B | | |
| Starch | | 0.5% |
| Silicone gum containing 12% A.M. (DC2-9085) | | 0.2% |
| (i.e. 0.024 dimethiconol and 0.176 dimethicone) | | |
| Gelling agents (phase C) | | |
| Hydroxyethylcellulose | | 0.1% |
| Carbomer (carbopol) | | 0.7% |
| Aqueous phase (phase D) | | |
| Preserving agent | | qs |
| Glycerol | | 5% |
| Water | qs | 100% |
| Phase E | | |
| Triethanolamine (neutralizer) | qs pH | 6 |

Procedure:

The oily and aqueous phases are prepared separately at 70° C. and the oily phase is poured into the aqueous phase with stirring. The mixture is stirred for 10 minutes to produce the emulsion, phase C is then added, followed by phase B and finally phase E to neutralize the carbopol.

A cream is obtained, which can be applied to the skin to protect it against the effects of pollution and especially to limit the adhesion of pollutant particles to the skin.

### Example 3: O/W Emulsion

| Oily phase (phase A) | | |
|---|---|---|
| Apricot oil | | 1% |
| Silicone oil | | 5% |
| Octyldodecanol (Eutanol G from the company Henkel) | | 1% |
| Screening agents (Parsol MCX, Mexoryl SX and | | |
| Eusolex 232) | | 9.5% |
| Phase B | | |
| Starch | | 0.5% |
| Silicone gum containing 12% A.M. (DC2-9085) | | 0.2% |
| (i.e. 0.024% dimethiconol and 0.176% dimethicone) | | |
| Gelling agents (phase C) | | |
| Hydroxyethylcellulose | | 0.1% |
| Carbomer (carbopol) | | 0.7% |
| Aqueous phase (phase D) | | |
| Preserving agent | | qs |
| Glycerol | | 5% |
| Water | qs | 100% |
| Phase E | | |
| Triethanolamine (neutralizer) | qs pH | 6 |

Procedure:

The oily and aqueous phases are prepared separately at 70° C. and the oily phase is poured into the aqueous phase with stirring. The mixture is stirred for 10 minutes to produce the emulsion, phase C is then added, followed by phase B and finally phase E to neutralize the carbopol.

A cream is obtained, which can be applied to the skin to protect it against the effects of pollution and especially to limit the adhesion of pollutant particles to the skin.

### Example 4: O/W Emulsion

| Oily phase (phase A) | | |
|---|---|---|
| Apricot oil | | 1% |
| Silicone oil | | 5% |
| Octyldodecanol (Eutanol G from the company Henkel) | | 1% |
| Screening agents (Parsol MCX, Mexoryl SX and | | |
| Eusolex 232) | | 9.5% |
| Phase B | | |
| Starch | | 0.5% |
| Gelling agents (phase C) | | |
| Hydroxyethylcellulose | | 0.1% |
| Carbomer (carbopol) | | 0.7% |
| Aqueous phase (phase D) | | |
| Preserving agent | | qs |
| Glycerol | | 5% |
| Water | qs | 100% |
| Phase E | | |
| Triethanolamine (neutralizer) | qs pH | 6 |

Procedure:

The oily and aqueous phases are prepared separately at 70° C. and the oily phase is poured into the aqueous phase with stirring. The mixture is stirred for 10 minutes to produce the emulsion, phase C is then added, followed by phase B and finally phase E to neutralize the carbopol.

A cream is obtained, which can be applied to the skin to protect it against the effects of pollution and especially to limit the adhesion of pollutant particles to the skin.

II. Demonstration of the Anti-Pollution Activity of Starch Alone and Combined with a Silicone Gum

To demonstrate the anti-pollution activity of starch and of the combination of starch and silicone gum, the compositions described above containing either 2% starch (Example 4) or 0.5% starch and 0.2% silicone gum (Examples 1 to 3) were tested. The placebos are the same compositions without starch or silicone gum.

1. Protocol Used

Biological Material:

Reconstructed human epidermides sold by the company Episkin® (Lyons, France) with its maintenance and testing media (Kit).

Reagents:

(1) Diesel particulates sold under the name Diesel Particules Matter 1650 by the National Institute of Standard Technology (ISA); (2) dry dust free compressed air sold under the name Souffl'sec by the company AF France; (3) artificial sebum.

The compressed air serves in the test to remove the particles not attached (adsorbed) to the surface of the skin, the aim being to mimic the air turbulences to which the skin and particulates are subjected in reality.

Apparatus and Equipment:

10 ml disposable polystyrene tubes and stoppers;

Curved stainless-steel spatula;

Balance with an accuracy of 1/10 mg (Mettler or the like);

Image analyser with black and white video camera equipped with a zoom lens of Leica Q500IW type or the like;

Microbiological safety station.

2. Test:

2 mg/cm² of sebum were placed on the reconstructed human epidermis using a curved spatula. The assembly was then left to dry in the open air (without a lid) under a laminar-flow fume cupboard for two hours.

The application of sebum makes it possible to obtain a skin more closely resembling real human skin, for example facial skin on which there is sebum, in vivo.

Next, the test compositions were applied to the reconstructed skin epidermis using a curved spatula, at a rate of 2 mg/cm². The compositions were left to dry in the open air (without a lid) under a laminar-flow fume cupboard for 30 minutes. 1.5 mg of diesel particulates were then placed thereon (in a safety station) and were distributed on the surface of the epidermis. The excess particulates were removed by turning the nacelle upside-down and the assembly was dried for 10 minutes in the open air (without a lid), after which the diesel particulates which had adhered, that is to say the soiled initial surface, were quantified by image analysis.

The assembly was then cleaned (in a safety station) by spraying dry air for 10 seconds at a distance of 25 cm from the nacelle. The assembly was left to dry for 10 minutes in the open air (without a lid) and the remaining particles, that is to say the remaining soiled surface, were quantified by image analysis.

3. Calculations

The percentage of particles removed is calculated according to the equation:

4. Results:

(In the tables below, SD means “standard deviation”).

$$\% particles removed = \frac{\begin{matrix}( soiled initial surface - \\ remaining soiled surface )\end{matrix}}{soiled initial surface} \times 100$$

| Anti-pollution | % particles | | |
|---|---|---|---|
| compounds | removed | SD | Significance |
| Example 1 according to the | 64.09 | 1.25 | p < 0.05 (relative to |
| invention | | | the placebo and to |
| | | | the sebum) |
| Placebo control | 47.09 | 3.79 | |
| Sebum control | 36.8 | 4.8 | |
| Example 2 according to the | 50 | 6.1 | |
| invention | | | |
| Placebo control | 40.5 | 4.5 | |
| Sebum control | 36.8 | 4.8 | |
| Example 3 according to the | 56.01 | 4.46 | p < 0.05 (relative to |
| invention | | | the sebum) |
| Placebo control | 51.2 | 2.58 | |
| Sebum control | 36.8 | 4.8 | |
| Example 4 according to the | 58.01 | 2.96 | p < 0.5 (relative to |
| invention | | | the sebum) |
| Placebo control | 46.76 | 4.54 | |
| Sebum control | 36.8 | 4.8 | |

The results indicated in the above tables show a significant anti-pollution effect (Student T, p<0.05) for the compositions containing a starch or a starch and a silicone gum, with respect to the standard diesel particles, compared with the epidermides surface-treated with sebum.

All documents mentioned herein are incorporated by reference, as is French Patent Application 0101645 filed Feb. 7, 2001.

Topical application is within the skill of the ordinary artisan, and includes for the present invention the application of, e.g., 0.5-5 g of composition to keratin materials once or more per day, for one or several days or longer. Application may be by any method, including by hand, with an applicator, etc. A person in need of the benefits of the invention is, e.g., anyone desirous of these specific benefits, whether on their own or on the advice of a professional such as a dermatologist, cosmetologist, beautician, etc., for example in response to a condition that would benefit from, e.g., protection of the skin from pollution.

1. A method of protecting keratin material from pollution, comprising topically applying to the keratin material of a person in need thereof a composition comprising an effective amount of starch.

2. The method of claim 1, wherein said keratin material is skin.

3. The method of claim 1, wherein in that the amount of starch in said composition ranges from 0.05 to 15% by weight relative to the total weight of the composition.

4. The method of claim 1, wherein the starch is selected from the group consisting of native or modified corn, rice, cassava, potato, wheat, sorghum and pea starch, and mixtures thereof.

5. The method of claim 4, wherein the starch is an unmodified starch.

6. The method of claim 1, wherein the starch is a corn starch.

7. The method of claim 1, wherein said composition further comprises a silicone gum.

8. The method of claim 7, wherein said silicone gum is a compound of formula (I): 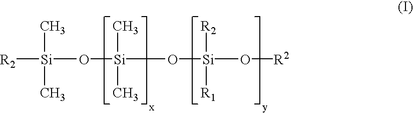
in which:
R1 represents —CH₃, —OH, —C₆H₅ or —OSi (CH₃)₃,
R2 represents —CH₃, —OH or —C₆H₅,
x=0 or an integer and
y is an integer, y or x+y being integers such that the weight-average molecular weight is greater than 100,000.

9. The method of claim 7, wherein the silicone gum is a dimethiconol.

10. The method of claim 7, wherein the amount of silicone gum ranges from 0.01% to 10% by weight relative to the total weight of the composition.

11. The method of claim 1, wherein said composition further comprises a sunscreen.

12. A composition comprising 1.) an unmodified starch selected from the group consisting of from corn starch, rice starch, cassava starch, potato starch, wheat starch, sorghum starch and pea starch, and 2.) a silicone gum.

13. The composition according to claim 12, wherein the starch is corn starch.

14. The composition according to claim 12, wherein silicone gum is a compound of formula (I): 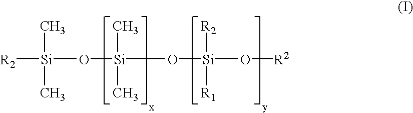
in which:
R1 represents —CH₃, —OH, —C₆H₅ or —OSi(CH₃)₃,
R2 represents —CH₃, —OH or —C₆H₅,
x=0 or an integer and y is an integer,
y or x+y being integers such that the weight-average molecular weight is greater than 100 000.

15. The composition according to claim 14, wherein the silicone gum is dimethiconol.

16. The composition according to claim 12, wherein the amount of starch ranges from 0.05 to 15% by weight relative to the total weight of the composition.

17. The composition according to claim 12, wherein the amount of silicone gum ranges from 0.01 to 10% by weight relative to the total weight of the composition.

18. The composition according to claim 12, further comprising a sunscreen.

19. The composition according to claim 18, wherein the amount of sunscreen ranges from 0.5% to 20% by weight relative to the total weight of the composition.

20. The composition according to claim 19, wherein the sunscreen is selected from the group consisting of octyl methoxycinnamate, terephthalylidenedicamphorsulphonic acid, benzophenone-3, phenylbenzimidazolesulphonic acid, and mixtures thereof.

21. The composition according to claim 12, in the form of an emulsion.

22. The composition according to claim 12, in the form of a gel.

23. A cosmetic treatment process for a keratin material in order to improve its cell respiration and/or to reduce its desquamation and/or to prevent it from becoming dull and/or dirty, which comprises applying to the keratin material of a person in need thereof a composition comprising an effective amount of starch.

24. The process according to claim 23, wherein the composition further comprises a silicone gum.

25. The process according to claim 23, wherein the keratin material is skin.

26. An article of manufacture comprising:
a composition comprising starch and optionally a silicone gum, and one or both of a) and b):
a) instructions for use of said composition as a pollution protectant, and
b) indicia indicating a pollution protectant ability of said composition.

27. The article of manufacture of claim 26, wherein said composition does comprise a silicone gum.
